(19) United States
(12) Patent Application Publication
(10) Pub. No.: US 2009/0196527 A1
(43) Pub. Date: Aug. 6, 2009

(54) Calibration method of image planar coordinate system for high-precision image measurement system

(75) Inventor: Kai-Ti Chen, Taichung (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/012,347

(22) Filed: Feb. 1, 2008

(51) Int. Cl. G06K 9/32; G06K 9/03; G01B 11/00

(52) U.S. Cl. 382/295; 73/1.79

(57) ABSTRACT

A calibration method of image planar coordinate system for a high-precision image measurement system comprises: at each time an X-Y coordinate of a measurement platform is moved, rotating and finely adjusting a two-dimension coordinate system of a calibration board or a workpiece and a projection plane coordinate system of a CCD camera so as to make the both coincide with the X-Y coordinate system.

### BACKGROUND OF THE INVENTION

1. Technical Field

The present invention relates to a calibration method of an image planar coordinate for high-precision image measurement.

2. Description of Related Art

Image measurement refers to using a CCD camera to capture images of an object to be measured, transforming the captured images into digital signals, and conducting mathematical calculation against the signals so as to obtain a measurement result. Various usages of the image measurement may generally include identifying defective products, recognizing articles, guiding machines, measuring dimensions and so on. By using the image measurement, the workpieces are free from contacting impacts and even minutes workpieces can be properly measured on the strength of image zooming-in effects.

An image measurement system has to be accurately calibrated before used for the aforementioned image measurement. In some particular measuring occasions, image measurement planes of CCD cameras may be limited. Therefore, errors in measurement parameters caused by installation of a CCD camera have to be taken into consideration. Namely, image planar coordinate axes of the CCD camera have to coincide with coordinate axes of a measurement platform.

In order to coincide the axes, a cross on a calibration board is used to present a cross on an output image of a software. Inner or outer threads may be formed on an optical lens barrel of the CCD camera so that the CCD camera can be adjusted manually in rotational movements to coincide the cross formed on the image plane and the virtual cross. Such approach relies on human visual observation and manual operation thereby consuming time and suffering from errors due to anthropogenic adjustment. Such errors, resulting in imaging errors of the lens of the CCD camera, may be too minute to be detected through human vision, yet can cause substantial deviation between the image of the workpiece captured by the CCD camera and the actual position of the workpiece. As shown in FIG. 1, the cross formed on the image plane by the calibration board seems to coincide with the virtual cross upon a visual observation, while a minute deviation that can not be visually recognized does exist therebetween. Though the deviation is minute, in an operation where the X-Y movement platform moves for a predetermined distance L2, such as an operation for LED wafer scribing, the accumulative deviation can incur obvious measurement errors or processing errors.

### SUMMARY OF THE INVENTION

The objective of the present invention is to provide a calibration method of an image planar coordinate system that facilitates achieving precise coincidence between axes of an image planar coordinate system of a CCD camera and a measurement platform so as to prevent imaging errors generated by a lens.

The disclosed calibration method of the image planar coordinate system for a high-precision image measurement system relates to coinciding a two-dimension coordinate of a calibration board or a workpiece with a projection plane coordinate system of the CCD camera at first and acquiring an image, then moving an X-Y coordinate system of a measurement platform for a predetermined distance and acquiring another image, calculating a deviation distance and a deviation angle between the former image and the latter image, rotating the calibration board (or the workpiece) and the CCD camera according to the deviation angle, and repeating the above steps until the deviation distance and the deviation angle between the former and latter images come to zero.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing showing that a cross of a calibration board seems to coincide with a virtual cross by a known approach under a naked-eye observation while an accumulative error emerges after an X-Y movement platform is moved;

FIG. 2 is a lateral view of a high-precision image measurement system of the present invention;

FIG. 3 is a top view of an X-axis measurement platform, a Y-axis measurement platform, a revolving spindle and a calibration board of FIG. 2;

FIG. 4 is a schematic drawing showing a two-dimension coordinate system (p-q), an X-Y coordinate system and a projection plane coordinate system (U-V) before calibration;

FIG. 5 is a schematic drawing showing the two-dimension coordinate system (p-q) and the projection plane coordinate system (U-V) calibrated by a Step A of the present invention;

FIG. 6 is a schematic drawing showing a first image and a second image acquired in a Step B of the present invention as well as a deviation distance and a deviation angle between positions of an object therein;

FIG. 7 is a schematic drawing showing that the projection plane coordinate system (U-V) is adjusted in the Step B according to the deviation angle of the positions of the object;

FIG. 8 is a schematic drawing showing that the two-dimension coordinate system (p-q), the X-Y coordinate system and the projection plane coordinate system (U-V) coincide in a Step C of the present invention; and

FIG. 9 is a schematic drawing showing that the deviation distance and the deviation angle of the positions of the object are zero.

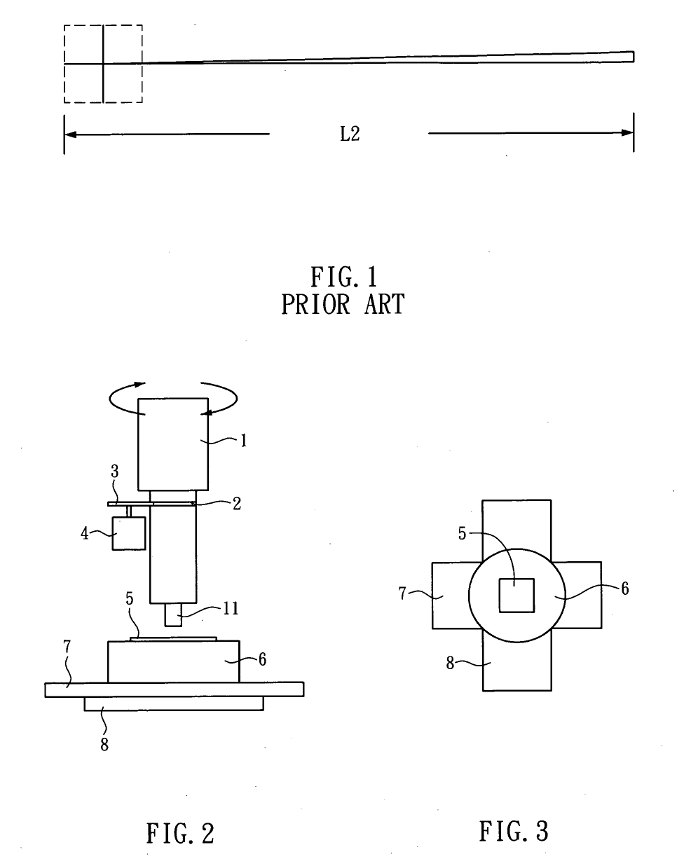

### DETAILED DESCRIPTION OF THE PREFERRED EMBODIMENT

While a preferred embodiments is provided herein for illustrating the concept of the present invention as described above, it is to be understood that the extent of deformation or displacement of the components in these drawings are made for better explanation and need not to be made in scale.

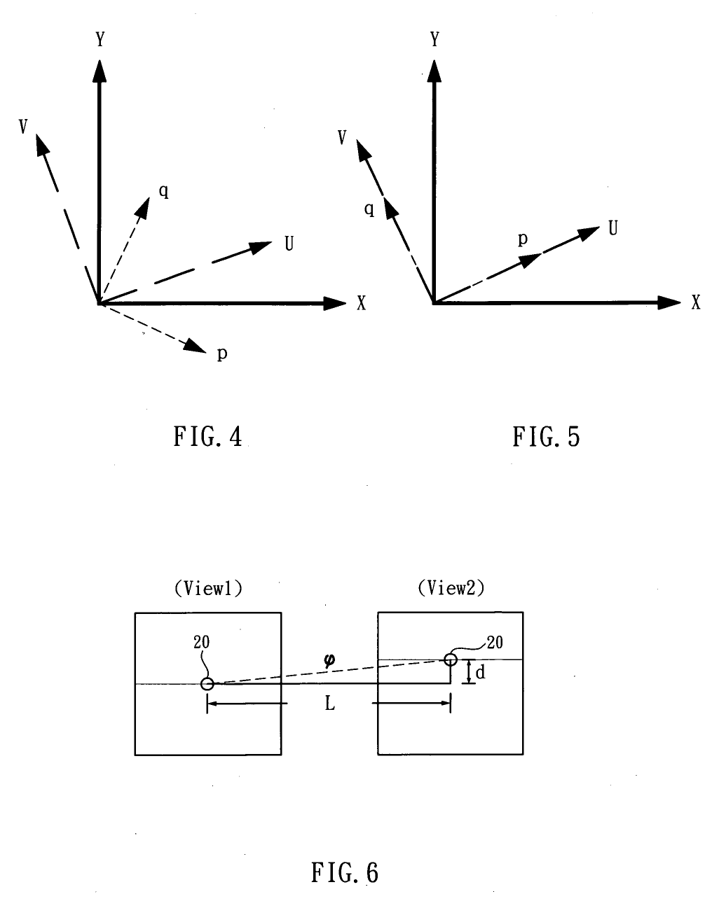

Referring to FIGS. 2, 3 and 4, hardware components implanted in the present invention include: a glass calibration board 5 (or a workpiece) affixed to a revolving spindle 6, wherein the glass calibration board 5 comprises a two-dimension coordinate system (p-q); an X-axis measurement platform 7 and a Y-axis measurement platform 8 which are settled below the revolving spindle 6 to form an X-Y coordinate system (X-Y); a CCD camera 1 installed above the revolving spindle 6, in which an optical lens barrel 11 thereof comprises a projection plane coordinate system (U-V); a power device driving the revolving spindle 6 to rotate the two-dimension coordinate system (p-q); and another power device, such as a stepping motor 4, driving gear assemblies 2, 3 to rotate the optical lens barrel 11 of the CCD camera 1 so as to in turn rotate the projection plane coordinate system (U-V). Therein, the X-axis measurement platform 7 can move back and forth along an X direction and the Y-axis measurement platform 8 can move back and forth along a Y direction.

A calibration method of the present invention comprises:

Step A: as shown in FIG. 5, using a knowing image processing method to calculate an azimuth of an image projected on the projection plane coordinate system (U-V) by the glass calibration board 5, thereby obtaining an angle between the two-dimension coordinate system (p-q) and the projection plane coordinate system (U-V) of the optical lens barrel 11, and rotating the revolving spindle 6 for the angle so as to in turn rotate the glass calibration board 5 for the angle, thereby coinciding the two-dimension coordinate system (p-q) and the projection plane coordinate system (U-V);

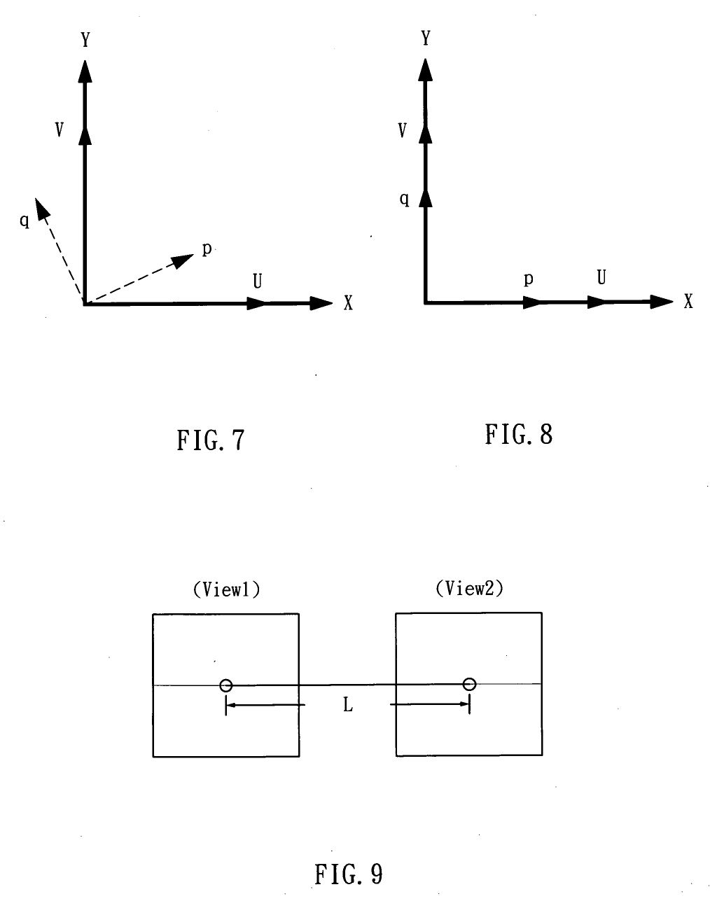

Step B: as shown in FIG. 6, acquiring a first image View 1 basing on the present X-Y coordinate system, moving the X-axis measurement platform 7 along the X direction or moving the Y-axis measurement platform 8 along the Y direction for a distance L, then acquiring a second image View 2 at the present position, calculating a horizontal or a vertical deviation distance d between the first image View 1 and the second image View 2 so as to derive an equation (φ=tan⁻¹ (d/L), wherein φ is the deviation angle between the projection plane coordinate system (U-V) of the optical lens barrel 11 and the X-Y coordinate system (X-Y), and then rotating the optical lens barrel 11 of the CCD camera 11 for φ degrees thereby coinciding the projection plane coordinate system (U-V) of the optical lens barrel 11 and the X-Y coordinate system (X-Y), as shown in FIG. 7;

Step C: using the Step A to coincide the two-dimension coordinate system (p-q) and the projection plane coordinate system (U-V), thereby achieving a coincidence of the two-dimension coordinate system (p-q), the projection plane coordinate system (U-V) and the X-Y coordinate system (X-Y), as shown in FIG. 8; and

Step D: conducting the Step B again to move the X-axis measurement platform 7 along the X direction or to move the Y-axis measurement platform 8 along the Y direction for another distance L and repeating the Steps B and C to finely adjust an angular deviation among the two-dimension coordinate system (p-q), the projection plane coordinate system (U-V) and the X-Y coordinate system (X-Y) until a complete coincidence of the three is finally achieved, upon the complete coincidence of the three, the horizontal or vertical deviation distance d between two positions of an identical object 20 in the first image View 1 and the second image View 2 derived in the Step B is zero, as shown in FIG. 9.

Although the particular embodiments of the invention have been described in detail for purposes of illustration, it will be understood by one of ordinary skill in the art that numerous variations will be possible to the disclosed embodiments without going outside the scope of the invention as disclosed in the claims.

What is claimed is:

1. A calibration method of image planar coordinate system for a high-precision image measurement system, comprising: coinciding a two-dimension coordinate system of a calibration board and a projection plane coordinate system of a CCD camera at an X-Y coordinate system of a measurement platform and acquiring an image; then moving the X-Y coordinate system for a predetermined distance and acquiring another image; calculating a deviation distance and a deviation angle between positions of an identical object in the two images acquired successively, rotating the calibration board and the CCD camera according to the deviation angle, and repeating the above steps until the deviation distance and the deviation angle between the positions of the object in the images acquired successively come to zero.

2. The calibration method of claim 1, comprising:
Step A: calculating an azimuth of an image projected on the projection plane coordinate system by the two-dimension coordinate system, and rotating the two-dimension coordinate system according to the azimuth so as to coincide the two-dimension coordinate system and the projection plane coordinate system;
Step B: acquiring a first image basing on the present X-Y coordinate system, moving the measurement platform along an X direction for a distance, then acquiring a second image at a present position, calculating a vertical deviation distance between the positions of the object in the first image and the second image, and then rotating the projection plane coordinate system according to the deviation angle so as to coincide the projection plane coordinate system and the X-Y coordinate system;
Step C: using the Step A to coincide the two-dimension coordinate system and the projection plane coordinate system; and
Step D: moving the measurement platform along the X direction for another distance and repeating the Steps B and C until the deviation distance and deviation angle between the positions of the object in the first image and the second come to zero.

3. The calibration method of claim 2, wherein the Step B further comprises moving the measurement platform along a Y direction for a distance and calculating a horizontal distance between the positions of the object in the first image and the second image.

4. The calibration method of claim 2, wherein, in the Step A, the two-dimension coordinate system is rotated by using a power device to rotate the calibration board.

5. The calibration method of claim 2, wherein, in the Step B, the projection plane coordinate system is rotated by using a power device to rotate an optical lens barrel of the CCD camera.

6. A calibration method of image planar coordinate system for a high-precision image measurement system, comprising at each time an X-Y coordinate of a measurement platform is moved, rotating and finely adjusting a two-dimension coordinate system of a calibration board or a workpiece and a projection plane coordinate system of a CCD camera so as to make the both coincide with the X-Y coordinate system.
